(19) United States
(12) Patent Application Publication
(10) Pub. No.: US 2020/0164718 A1
(43) Pub. Date: May 28, 2020

(54) TEMPERATURE ADJUSTMENT SYSTEM

(71) Applicant: KEIHIN CORPORATION, Tokyo (JP)

(72) Inventors: Natsuki TAKEI, Utsunomiya-shi (JP); Takenori SUMIYA, Utsunomiya-shi (JP)

(21) Appl. No.: 16/595,710

(22) Filed: Oct. 8, 2019

(30) Foreign Application Priority Data
Nov. 22, 2018 (JP) 2018-219197

(51) Int. Cl. B60H 1/00; B60L 58/26

(52) U.S. Cl. CPC B60H 1/00885; B60H 1/00485; B60L 58/26

(57) ABSTRACT

There is provided a temperature adjustment system which performs temperature adjustment of one or a plurality of instruments installed in a vehicle, the temperature adjustment system comprising: a heat medium temperature regulating device which is configured to regulate a temperature of a heat medium; a heat medium supplying device which is configured to supply, to the instrument, the heat medium subjected to temperature regulation in the heat medium temperature regulating device; a bypass flow rate regulating device which is configured to regulate a passage flow rate of the heat medium in a stepwise manner, which is provided to bypass the heat medium temperature regulating device; a temperature measuring device which is configured to measure a temperature of the instrument; and a controlling device which is configured to control the bypass flow rate regulating device based on the measured temperature.

### CROSS REFERENCE TO RELATED APPLICATION

The present invention claims priority under 35 U.S.C. § 119 to Japanese Patent Application No. 2018-219197, filed on Nov. 22, 2018, the entire content of which is incorporated herein by reference.

### BACKGROUND OF THE INVENTION

### Field of the Invention

The present invention relates to a temperature adjustment system.

### Description of Related Art

Japanese Unexamined Patent Application, First Publication No. 2009-126256 discloses a cooling device for a vehicle in which a battery, an inverter, and a motor are disposed in a cooling medium flow path in a hybrid vehicle or an electric vehicle such that the battery, the inverter, and the motor are cooled.

In the case of such a cooling device, as shown in FIG. 6, FIG. 7, or FIG. 9 in Japanese Unexamined Patent Application, First Publication No. 2009-126256, a cooling medium is caused to flow switching between a route through a radiator and a route bypassing the radiator such that the battery, the inverter, and the motor are effectively cooled.

### SUMMARY OF THE INVENTION

Meanwhile, a configuration in the above-described related art is a configuration in which the cooling medium is caused to flow selectively switching between the route through the radiator and the route bypassing the radiator, that is, a configuration in which whether the cooling medium is forcibly cooled by the radiator or the cooling medium is not cooled is selectively selected. Therefore, it is difficult to cope with a case where finer heat management of the battery, the inverter, and the motor is required.

The present invention has been made in consideration of the above-described problem and an object thereof is to provide a temperature adjustment system with which it is possible to perform finer heat management than that in the related art.

In order to achieve the above-described object, the present invention adopts the following aspects.

(1) According to an aspect of the invention, there is provided a temperature adjustment system which performs temperature adjustment of one or a plurality of instruments installed in a vehicle, the temperature adjustment system comprising: a heat medium temperature regulating device which is configured to regulate a temperature of a heat medium; a heat medium supplying device which is configured to supply, to the instrument, the heat medium subjected to temperature regulation in the heat medium temperature regulating device; a bypass flow rate regulating device which is configured to regulate a passage flow rate of the heat medium in a stepwise manner, and which is provided to bypass the heat medium temperature regulating device; a temperature measuring device which is configured to measure a temperature of the instrument; and a controlling device which is configured to control the bypass flow rate regulating device based on the measured temperature.

(2) In the temperature adjustment system according to (1), a plurality of the instruments may be provided, the temperature adjustment system may further comprise a switching valve that switches between flow paths of the heat medium, and the controlling device may control the switching valve based on the measured temperature.

(3) In the temperature adjustment system according to (1) or (2), the instrument may be a battery and the controlling device may control an opening degree of the bypass flow rate regulating device based on a battery temperature measured by the temperature measuring device.

(4) In the temperature adjustment system according to any one of (1) to (3), the heat medium temperature regulating device may be a radiator that cools the heat medium.

(5) In the temperature adjustment system according to any one of (1) to (4), the instruments may be a battery, a power converter, and a charger.

According to the present invention, it is possible to provide a temperature adjustment system with which it is possible to perform finer heat management than that in the related art.

### BRIEF DESCRIPTION OF THE DRAWINGS

FIG. 1 is a system diagram illustrating the configuration of a temperature adjustment system according to an embodiment of the present invention.

FIG. 2 is a first flowchart illustrating the operation of the temperature adjustment system according to the embodiment of the present invention.

FIG. 3 is a second flowchart illustrating the operation of the temperature adjustment system according to the embodiment of the present invention.

### DETAILED DESCRIPTION OF THE INVENTION

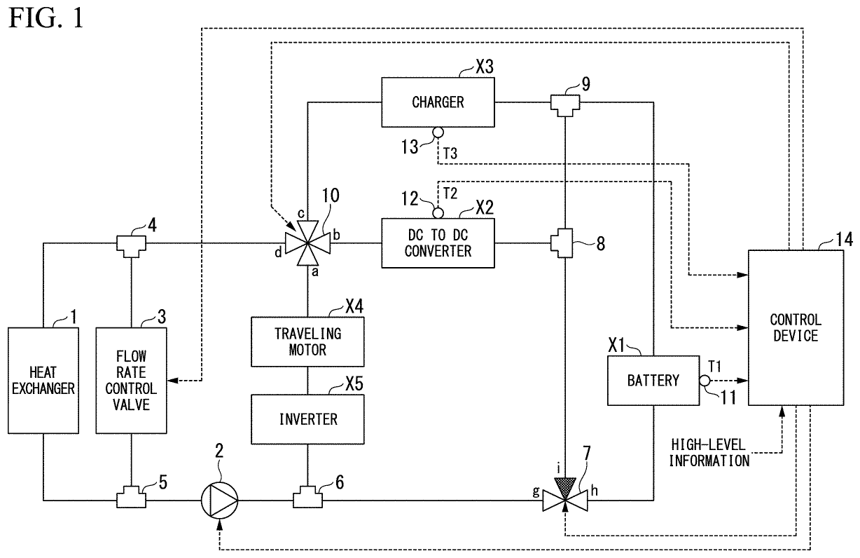

Hereinafter, an embodiment of the present invention will be described with reference to drawings. A temperature adjustment system according to the present embodiment is a system installed in a vehicle such as a hybrid electric vehicle or an electric vehicle and performs temperature regulation of a battery X1, a DC-to-DC converter X2, a charger X3, a traveling motor X4 and an inverter X5 by means of cooling water (heat medium) as shown in FIG. 1. That is, the targets of the temperature regulation performed by the temperature adjustment system are the battery X1, the DC-to-DC converter X2, the charger X3, the traveling motor X4, and the inverter X5 from among various heat generating instruments installed in a vehicle such as an automobile.

The battery X1 is an assembled battery obtained by combining a plurality of battery cells with each other and is a power source from which power is supplied to the traveling motor X4. The DC-to-DC converter X2 is provided between the battery X1 and the traveling motor X4 and is a voltage step-down circuit that lowers the voltage of output (DC power) of the battery X1.

In addition, the DC-to-DC converter X2 is provided between the charger X3 and the battery X1 and the DC-to-DC converter X2 lowers the voltage of output (DC power) of the charger X3 and supplies the output to the battery X1 in a case where the battery X1 is charged. The charger X3 is a power circuit charging the battery X1 with power from an external power source such as a commercial power supply and supplies DC power to the battery X1 via the DC-to-DC converter X2.

The traveling motor X4 is a traveling power source for the vehicle and drives vehicle wheels to rotate. The inverter X5 is provided between the DC-to-DC converter X2 and the traveling motor X4, converts DC power input from the DC-to-DC converter X2 into AC power, and supplies the AC power to the traveling motor X4. In a case where the vehicle is in a traveling state, the DC-to-DC converter X2, the traveling motor X4, and the inverter X5 exhibit similar thermal behaviors.

The battery X1, the DC-to-DC converter X2, the charger X3, the traveling motor X4, and the inverter X5 are heat generating instruments that generate a relatively large amount of heat and are instruments that need to be forcibly cooled by means of cooling water. Note that, from among the battery X1, the DC-to-DC converter X2, the charger X3 the traveling motor X4, and the inverter X5, the DC-to-DC converter X2 and the inverter X5 are power converters in the present invention.

Such a temperature adjustment system is provided with, as shown in FIG. 1, a heat exchanger 1, a circulation pump 2, a flow rate control valve 3, a first splitter 4, a first combiner 5, a second splitter 6, a three-way valve 7, a third splitter 8, a fourth splitter 9, a four-way valve 10, a first temperature sensor 11, a second temperature sensor 12, a third temperature sensor 13, and a control device 14.

The heat exchanger 1 is heat medium temperature regulating device for cooling cooling water (temperature adjustment) and is, for example, a radiator. The heat exchanger 1 cools cooling water supplied from the first splitter 4 by means of heat exchange with outside air and discharges the cooling water to the first combiner 5. The circulation pump 2 is a pump that sucks cooling water flowing thereinto from the first combiner 5 and discharges the cooling water toward the second splitter 6. The flow rate control valve 3 is a control valve of which the opening degree is controlled in a stepwise manner by the control device 14. The flow rate control valve 3 regulates the passage flow rate of cooling water supplied from the first splitter 4 in a stepwise manner and discharges the cooling water to the first combiner 5. The flow rate control valve 3 corresponds to bypass flow rate regulating device in the present invention.

The first splitter 4 splits cooling water supplied from the four-way valve 10 and discharges the cooling water toward the heat exchanger 1 and the flow rate control valve 3. The first combiner 5 combines cooling water flowing thereinto from the heat exchanger 1 and cooling water flowing thereinto from the flow rate control valve 3 with each other and discharges the cooling water to the circulation pump 2. The second splitter 6 splits cooling water flowing thereinto from the circulation pump 2 and discharges the cooling water toward the three-way valve 7 and the inverter X5.

The three-way valve 7 is a control valve that is provided with three ports h, i, and g and is controlled by the control device 14. The three-way valve 7 discharges, toward the battery X1 or toward the battery X1 and the third splitter 8, cooling water flowing thereinto from the second splitter 6. That is, the port h of the three-way valve 7 is connected to the battery X1, the port i of the three-way valve 7 is connected to the third splitter 8, and the port g of the three-way valve 7 is connected to the second splitter 6. The three-way valve 7 is a switching valve that switches between flow paths of cooling water (heat medium).

The third splitter 8 splits cooling water flowing thereinto from the three-way valve 7 and the fourth splitter 9 and discharges the cooling water toward the DC-to-DC converter X2 and the fourth splitter 9. The fourth splitter 9 discharges, toward the charger X3, cooling water flowing thereinto from the third splitter 8 and the battery X1. Note that, a direction in which cooling water between the third splitter 8 and the fourth splitter 9 flows is changed depending on the state of the three-way valve 7.

The four-way valve 10 is a control valve that is provided with four ports a, b, c, and d and is controlled by the control device 14. The state of the four ports a, b, c, and d of the four-way valve 10 are set to be a fully-open state basically and two ports c and d from among the four ports a, b, c, and d or the other two ports a and b enter a closed state based on a control signal input from the control device 14. Note that, the four-way valve 10 is a switching valve that switches between flow paths of cooling water (heat medium) as with the three-way valve 7.

Here, the battery X1, the DC-to-DC converter X2, the charger X3, the traveling motor X4, the inverter X5, the heat exchanger 1, the circulation pump 2, the flow rate control valve 3, the first splitter 4, the first combiner 5, the second splitter 6, the three-way valve 7, the third splitter 8, the fourth splitter 9, and the four-way valve 10 as described above are connected one another via a plurality of pipes as represented by solid lines in FIG. 1 such that cooling water flows therebetween.

For example, the traveling motor X4 and the inverter X5 are provided in the middle of a pipe that connects the second splitter 6 and the four-way valve 10 to each other. The cooling water discharged from the second splitter 6 flows into the four-way valve 10 after passing through the inverter X5 and passing through the traveling motor X4. Note that, the circulation pump 2, the flow rate control valve 3, the first splitter 4, the first combiner 5, the second splitter 6, the three-way valve 7, the third splitter 8, the fourth splitter 9, and the four-way valve 10, which are connected one another via a pipe constitute heat medium supplying device in the present invention.

The first temperature sensor 11 is provided being accompanied by the battery X1, measures the temperature of the battery X1 (battery temperature T1), and outputs the measured temperature to the control device 14. The second temperature sensor 12 is provided being accompanied by the DC-to-DC converter X2, measures the temperature of the DC-to-DC converter X2 (converter temperature T2), and outputs the measured temperature to the control device 14. The third temperature sensor 13 is provided being accompanied by the charger X3, measures the temperature of the charger X3 (charger temperature T3), and outputs the measured temperature to the control device 14. The first temperature sensor 11, the second temperature sensor 12, and the third temperature sensor 13 correspond to temperature measuring device in the present invention.

The control device 14 controls the circulation pump 2, the flow rate control valve 3, the three-way valve 7, and the four-way valve 10 based on the battery temperature T1, the converter temperature T2 and the charger temperature T3. That is, the control device 14 controls the rotation rate of the circulation pump 2, the opening degree of the flow rate control valve 3, the opening and closing of the ports h, i, and g of the three-way valve 7 and the opening and closing of ports a, b, c, and d of the four-way valve 10. The controlling will be described in detail in the following description about operations.

In addition, as shown in the drawing, necessary information relating to cooling control of a temperature regulation target is introduced into the control device 14 as high-level control information, from a high-level control device that controls the entire vehicle. The control device 14 controls the circulation pump 2, the flow rate control valve 3, the three-way valve 7, and the four-way valve 10 while referring to the high-level control device in addition to the battery temperature T1, the converter temperature T2, and the charger temperature T3. Note that, the control device 14 corresponds to controlling device in the present invention.

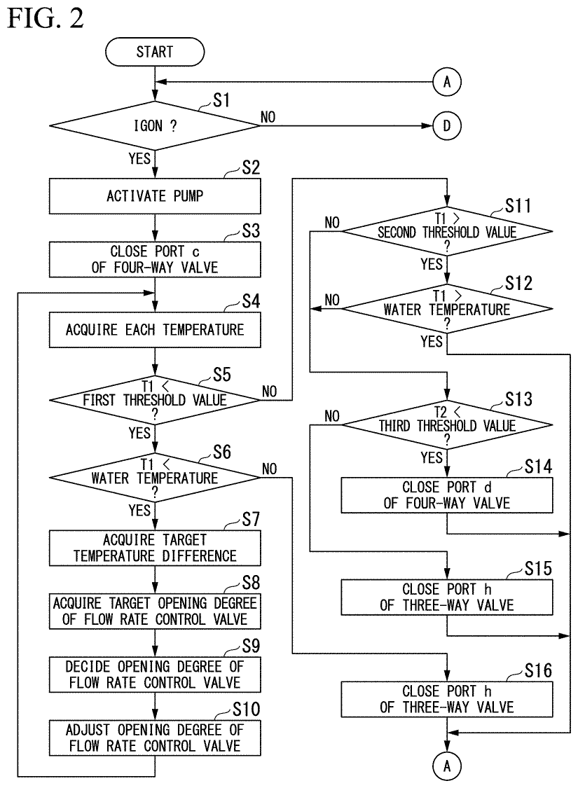

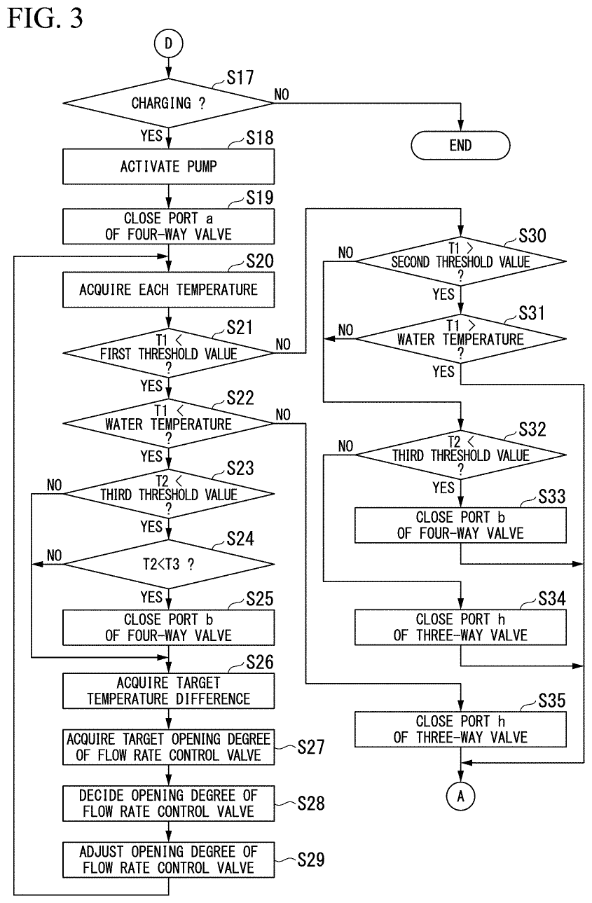

Next, the operation of the temperature adjustment system according to the present embodiment will be described by using flowcharts shown in FIG. 2 and FIG. 3.

Note that, the control device 14 initially sets the state of the flow rate control valve 3 to a fully-closed state (opening degree=0). In addition, in an initial state, the control device 14 sets the state of the port i of the three-way valve 7 to a closed state and sets the state of the other ports h and g to an open state such that the cooling water flowing into the three-way valve 7 from the second splitter 6 can be discharged only to the battery X1.

Furthermore, in the initial state, the control device 14 sets the state of all of the ports a, b, c, and d of the four-way valve 10 to an open state such that cooling water flowing into the four-way valve 10 from the DC-to-DC converter X2, cooling water flowing into the four-way valve 10 from the charger X3, and cooling water flowing into the four-way valve 10 from the traveling motor X4 can be discharged to the first splitter 4.

In such an initial state, the control device 14 acquires the ON-OFF state of an ignition switch (IG) of the vehicle as the high-level control information and when the control device 14 detects “IGON” which represents that the ignition switch is in an ON state (Step S1), the circulation pump 2 is activated (Step S2) and the state of the port c of the four-way valve 10 is set to a closed state (Step S3).

As a result, cooling water discharged from the circulation pump 2 flows into the port a of the four-way valve 10 after passing through the second splitter 6, the inverter X5, and the traveling motor X4 in this order. In addition, cooling water discharged from the circulation pump 2 flows into the port b of the four-way valve 10 after passing through the second splitter 6, the three-way valve 7, the battery X1, the fourth splitter 9, the third splitter 8, the DC-to-DC converter X2 in this order.

Furthermore, the cooling water which has passed through the two routes is heated cooling water heated by heat from the battery X1, the DC-to-DC converter X2, the traveling motor X4, and the inverter X5. Such heated cooling water flows into the heat exchanger 1 from the port d of the four-way valve 10 via the first splitter 4 and is cooled therein. Then, cooling water discharged from the heat exchanger 1 is sucked into the circulation pump 2 via the first combiner 5 and is discharged toward the second splitter 6 again.

That is, with the circulation pump 2 activated, the battery X1, the DC-to-DC converter X2, the traveling motor X4, and the inverter X5 (almost all of temperature regulation targets) are cooled by the cooling water and the cooling water heated during the cooling is supplied to the targets of the temperature regulation again after being cooled by the heat exchanger 1. The cooling water circulating as described above continuously cools almost all of the temperature regulation targets excluding the charger X3.

Next, the control device 14 acquires the battery temperature T1, the converter temperature T2, and the charger temperature T3 from the first temperature sensor 11, the second temperature sensor 12, and the third temperature sensor 13 (Step S4) and determines whether the battery temperature T1 is lower than a first threshold value or not (Step S5). In a case where the result of the determination in Step S5 is “Yes”, the control device 14 determines whether the battery temperature T1 is lower than a water temperature or not (Step S6) and in a case where the result of the determination in Step S6 is “Yes”, the control device 14 acquires a target temperature difference (Step S7). Note that, the first threshold value is, for example, 25° C.

The target temperature difference is a difference between a control target temperature of the battery X1 and the battery temperature T1. When the control device 14 acquires (calculates) the target temperature difference, the control device 14 acquires a target opening degree of the flow rate control valve 3 corresponding to the target temperature difference (Step S8). A control map, which shows a correspondence between the target temperature difference and the target opening degree, is stored in the control device 14 in advance and the control device 14 acquires the target opening degree based on the control map.

Then, the control device 14 decides the target opening degree as a control opening degree of the flow rate control valve 3 (Step S9) and adjusts the flow rate control valve 3 such that the opening degree thereof reaches the target opening degree (Step S10). When a process of adjusting the opening degree of the flow rate control valve 3 is finished, the control device 14 repeats the process in Step S4 and repeats the processes in Steps S5 to S10 for each temperature acquired in Step S4.

As a result, the flow rate (passage flow rate) of cooling water passing through the heat exchanger 1 is finely regulated in a stepwise manner. That is, a ratio between the flow rate (passage flow rate) of cooling water that passes through the heat exchanger 1 and that is a portion of cooling water discharged from the port d of the four-way valve 10 and the flow rate (passage flow rate) of cooling water that bypasses the heat exchanger 1 and passes through the flow rate control valve 3 is finely adjusted in a stepwise manner. The ratio corresponds to the target temperature difference and the larger the target temperature difference is, the higher the flow rate (passage flow rate) of the cooling water passing through the heat exchanger 1 and a cooling performance with respect to the heated cooling water are. Therefore, according to the present embodiment, it is possible to perform fine heat management of the battery X1 in accordance with the battery temperature T1.

Note that, in a case where the result of the determination in Step S5 is “No”, the control device 14 determines whether the battery temperature T1 is higher than a second threshold value or not (Step S11). In a case where the result of the determination in Step S11 is “Yes”, the control device 14, the control device 14 determines whether the battery temperature T1 is higher than a water temperature (Step S12) and in a case where the result of the determination in Step S12 is “Yes”, the control device 14 repeats Step S1 without changing the opening degree of the flow rate control valve 3 in the fully closed state. The second threshold value is, for example, 35° C.

That is, the control device 14 sets an appropriate value of the battery temperature T1 to be equal to or higher than the first threshold value (for example, 25° C.) and equal to or lower than the second threshold value (for example, 35° C.) and the control device 14 changes, in a fully opening direction, the opening degree of the flow rate control valve 3 in the fully closed state such that a cooling performance of the heat exchanger 1 with respect to the heated cooling water is lowered only in a case where the battery temperature T1 is lower than the first threshold value. Accordingly, the battery temperature T1 is increased to be equal to or higher than the first threshold value.

Here, in a case where the result of the determination in Step S11 is “No” or in a case where the result of the determination in Step S12 is “No”, that is, in a case where the battery temperature T1 falls in an appropriate range, the control device 14 determines whether the converter temperature T2 is lower than a third threshold value or not (Step S13). The third threshold value is, for example, 25° C. and is an index indicating an appropriate temperature of the DC-to-DC converter X2.

In a case where the result of the determination in Step S13 is “Yes”, the control device 14 sets the state the port d, which is one of the ports a, b, c, and d of the four-way valve 10, to a closed state from an open state (Step S14). That is, in this case, since the temperature of the DC-to-DC converter X2 is the appropriate temperature, the control device 14 stops supply of cooling water to the DC-to-DC converter X2.

Meanwhile, in a case where the result of the determination in Step S13 is “No”, the control device 14 sets the state of the port h of the three-way valve 7 to a closed state from an open state (Step S15). That is, in this case, supply of cooling water to the battery X1 and the DC-to-DC converter X2 is stopped. When the processes in Steps S14 and S15 are finished, the control device 14 repeats Step S1 again.

In addition, in a case where the result of the determination in Step S6 is “No” as well, the control device 14 sets the state of the port h of the three-way valve 7 to a closed state from an open state (Step S16). In this case also, supply of cooling water to the battery X1 and the DC-to-DC converter X2 is stopped such that cooling water discharged from the circulation pump 2 is supplied only for the cooling of the traveling motor X4 and the inverter X5.

Next, in a case where the result of the determination in Step S1 is “No”, that is, in a case where the ignition switch of the vehicle is not set “ON”, the control device 14 determines whether the battery X1 is being charged or not, that is, whether the charger X3 is being operated or not (Step S17). That is, the control device 14 determines the state of operation of the charger X3 based on the high-level control information and in a case where the result of the determination is “Yes”, the control device 14 activates the circulation pump 2 (Step S18) and sets the state of the port a of the four-way valve 10 to a closed state (Step S19).

In this case, that is, in a state where the battery X1 is charged by the charger X3, the vehicle is in a stopped state, the traveling motor X4 and the inverter X5 do not generate heat, and thus it is not necessary to cool the traveling motor X4 and the inverter X5. Therefore, the control device 14 sets the state of the port a of the four-way valve 10 to a closed state such that supply of cooling water to the traveling motor X4 and the inverter X5 is stopped.

Here, the charging of the battery X1 which is performed by the charger X3 is performed via the DC-to-DC converter X2. Therefore, in a case where the battery X1 is in a charged state, the DC-to-DC converter X2 may also generate heat as with the battery X1 and the charger X3.

Then, the control device 14 acquires the battery temperature T1, the converter temperature T2, and the charger temperature T3 from the first temperature sensor 11, the second temperature sensor 12, and the third temperature sensor 13 (Step S20). Then, the control device 14 determines whether the battery temperature T1 is lower than the first threshold value or not (Step S21) and in a case where the result of the determination in Step S21 is “Yes”, the control device 14 determines whether the battery temperature T1 is lower than a water temperature or not (Step S22).

Furthermore, in a case where the result of the determination in Step S22 is “Yes”, the control device 14 determines whether the converter temperature T2 is lower than the third threshold value or not (Step S23) and in a case where the result of the determination in Step S23 is “Yes”, the control device 14 determines whether the converter temperature T2 is lower than the charger temperature T3 or not (Step S24). In a case where the result of the determination in Step S24 is “Yes”, the control device 14 sets the state of the port b of the four-way valve 10 to a closed state from an open state (Step S25).

That is, in this case, since it is necessary to give a higher priority to the cooling of the charger X3 than the cooling of the DC-to-DC converter X2, all of cooling water discharged from the battery X1 is supplied to the charger X3. As a result, the charger X3 is cooled in preference to the DC-to-DC converter X2.

In addition, in this case, the control device 14 acquires the target temperature difference of the battery X1 (Step S26) and acquires the target opening degree of the flow rate control valve 3 corresponding to the target temperature difference (Step S27). Then, the control device 14 decides the target opening degree as the control opening degree of the flow rate control valve 3 (Step S28) and adjusts the flow rate control valve 3 such that the opening degree thereof reaches the target opening degree (Step S29). When a process of adjusting the opening degree of the flow rate control valve 3 is finished, the control device 14 repeats the process in Step S20 and repeats the processes in Steps S21 to S29 for each temperature acquired in Step S20.

As a result, the flow rate of heated cooling water passing through the heat exchanger 1 is regulated in a stepwise manner. That is, a ratio between the flow rate of heated cooling water that passes through the heat exchanger 1 and that is a portion of heated cooling water discharged from the port d of the four-way valve 10 and the flow rate of heated cooling water that bypasses the heat exchanger 1 and passes through the flow rate control valve 3 is finely adjusted in a stepwise manner and thus fine heat management of the battery X1 is realized.

Note that, in a case where the result of the determination in Step S21 is “No”, the control device 14 determines whether the battery temperature T1 is higher than the second threshold value or not (Step S30). In a case where the result of the determination in Step S30 is “Yes”, the control device 14 determines whether the battery temperature T1 is higher than a water temperature or not (Step S31) and in a case where the result of the determination in Step S31 is “Yes”, the control device 14 repeats Step S1.

That is, even in a case where the battery X1 is being charged, the control device 14 changes, in a fully opening direction, the opening degree of the flow rate control valve 3 in the fully closed state such that the cooling performance of the heat exchanger 1 with respect to the heated cooling water is lowered only in a case where the battery temperature T1 is lower than the first threshold value. Accordingly, the battery temperature T1 is increased to be equal to or higher than the first threshold value.

Here, in a case where the result of the determination in Step S30 is “No” or in a case where the result of the determination in Step S31 is “No”, that is, in a case where the battery temperature T1 falls in an appropriate range, the control device 14 determines whether the converter temperature T2 is lower than the third threshold value or not (Step S32). In a case where the result of the determination in Step S32 is “Yes”, the control device 14 sets the state the port d of the four-way valve 10 to a closed state from an open state (Step S33). That is, in this case, since the temperature of the DC-to-DC converter X2 is the appropriate temperature, the control device 14 stops supply of cooling water to the DC-to-DC converter X2.

Meanwhile, in a case where the result of the determination in Step S32 is “No”, the control device 14 sets the state of the port h of the three-way valve 7 to a closed state from an open state (Step S34). That is, in this case, supply of cooling water to the battery X1 and the DC-to-DC converter X2 is stopped. When the processes in Steps S33 and S34 are finished, the control device 14 repeats Step S1 again.

Furthermore, in a case where the result of the determination in Step S22 is “No” as well, the control device 14 sets the state of the port h of the three-way valve 7 to a closed state from an open state (Step S35). In this case also, supply of cooling water to the battery X1 and the DC-to-DC converter X2 is stopped such that cooling water discharged from the circulation pump 2 is supplied only for the cooling of the traveling motor X4 and the inverter X5.

According to the present embodiment, since the flow rate control valve 3 is provided in parallel to the heat exchanger 1, the passage flow rate of heated cooling water in the heat exchanger 1 can be finely regulated in a stepwise manner. Accordingly, it is possible to perform finer heat management with respect to the battery X1 than that in the related art.

Note that, the present invention is not limited to a configuration as in the above-described embodiment and modification examples as follows are conceivable.

(1) In the above-described embodiment, a plurality of instruments as temperature regulation targets are provided. However, the present invention is not limited to this configuration. A portion of the battery X1, the DC-to-DC converter X2, the charger X3, the traveling motor X4, and the inverter X5 (for example, only battery X1) may be subjected to temperature regulation.

(2) In the above-described embodiment, fine heat management with respect to the battery X1 is realized. However, the present invention is not limited to this configuration. For example, fine heat management with respect to any of the DC-to-DC converter X2, the charger X3, the traveling motor X4, the inverter X5 may be realized based on the temperature of any of the DC-to-DC converter X2, the charger X3, the traveling motor X4, the inverter X5.

(3) In the above-described embodiment, the plurality of temperature regulation targets are present and thus the three-way valve 7 and the four-way valve, which are switching valves, are provided to switch between flow paths of cooling water (heat medium). However, the present invention is not limited to this configuration. For example, even in a case where the plurality of temperature regulation targets are present, a flow path of cooling water (heat medium) may be configured with no switching valve. That is, the switching valves are not essential constituent elements in the present invention.

(4) In the above-described embodiment, the heat medium temperature regulating device is a radiator. However, the present invention is not limited to this configuration. Heat medium temperature regulating device (heat medium cooling device) other than the radiator may be provided or other heat medium temperature regulating device (heat medium cooling device) may be provided in addition to the radiator.

According to the present invention, it is possible to provide a temperature adjustment system with which it is possible to perform finer heat management than that in the related art.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

X1 battery
X2 DC-to-DC converter
X3 charger
X4 traveling motor
X5 inverter
1 heat exchanger
2 circulation pump
3 flow rate control valve
4 first splitter
5 first combiner
6 second splitter
7 three-way valve
8 third splitter
9 fourth splitter
10 four-way valve
11 first temperature sensor
12 second temperature sensor
13 third temperature sensor
14 control device

What is claimed is:

1. A temperature adjustment system which performs temperature adjustment of one or a plurality of instruments installed in a vehicle, the temperature adjustment system comprising:
a heat medium temperature regulating device which is configured to regulate a temperature of a heat medium;
a heat medium supplying device which is configured to supply, to the instrument, the heat medium subjected to temperature regulation in the heat medium temperature regulating device;
a bypass flow rate regulating device which is configured to regulate a passage flow rate of the heat medium in a stepwise manner, and which is provided to bypass the heat medium temperature regulating device;
a temperature measuring device which is configured to measure a temperature of the instrument; and
a controlling device which is configured to control the bypass flow rate regulating device based on the measured temperature.

2. The temperature adjustment system according to claim 1,
wherein a plurality of the instruments are provided,
wherein the temperature adjustment system further comprises a switching valve that switches between flow paths of the heat medium, and
wherein the controlling device controls the switching valve based on the measured temperature.

3. The temperature adjustment system according to claim 1,
wherein the instrument is a battery, and
wherein the controlling device controls an opening degree of the bypass flow rate regulating device based on a battery temperature measured by the temperature measuring device.

4. The temperature adjustment system according to claim 1,
wherein the heat medium temperature regulating device is a radiator that cools the heat medium.

5. The temperature adjustment system according to claim 1,
wherein the instruments are a battery, a power converter, and a charger.
